(19) United States
(12) Patent Application Publication
(10) Pub. No.: US 2011/0125562 A1
(43) Pub. Date: May 26, 2011

(54) Methods of Arranging Contracts for Wedding-Related Goods and/or Services

(76) Inventor: Yanni Elyash, Northbrook, IL (US)

(21) Appl. No.: 12/622,954

(22) Filed: Nov. 20, 2009

(51) Int. Cl. G06Q 30/00; G06Q 10/00; G06Q 50/00

(52) U.S. Cl. 705/14.16; 705/14.51; 705/14.69; 705/14.7; 705/26.1

(57) ABSTRACT

A method of arranging contracts for wedding-related goods and/or services through an Internet-based platform wherein advertising vendors pay a fee only if a contract is entered into with customers of the advertising vendors.

### FIELD OF THE INVENTION

The invention generally relates to commerce, and more particularly, to methods of arranging contracts for wedding-related goods and/or services.

### BACKGROUND OF THE INVENTION

In the wedding industry, online advertising plays a major role as wedding vendors need to advertise their services to prospective customers, in particular, the brides-to-be. While there are many websites that provide advertising platforms for wedding vendors, they are deficient in some aspects.

For example, wedding vendors usually have to pay a substantial sign-up fee to be able to advertize on a website and/or pay monthly charges. This business model results in wedding vendors having to pay substantial fees without any guarantee of clientele. This discourages online advertising because wedding vendors are reluctant to pay substantial fees without a guaranteed return on the investment.

Accordingly, there is a need in the art for a new model of advertising for wedding-related services.

### BRIEF SUMMARY OF THE INVENTION

In one embodiment, the invention provides a method of arranging contracts for wedding-related goods and/or services, the method including the steps of:

setting up an Internet-based platform through which:
a) advertising vendors offer wedding-related goods and/or services; and
b) customers identify the Advertising vendors' offered goods and/or services;
facilitating negotiation of contracts for the wedding-related goods and/or services between the advertising vendors and customers brought together through the Internet-based platform; and
charging said advertising vendors a fee for offering wedding-related goods and/or services only in the event that a contract for wedding-related goods and/or services is entered into between said advertising vendors and customers brought together through the Internet-based platform.

In one embodiment, the methods of the invention allow advertising vendors to provide information which includes, but is not limited to, a business name, a business address, an electronic mail address, a telephone number, and a facsimile number.

In a preferred embodiment, the methods of the invention further include a step of sharing a proportion of said fee for using the Internet-based platform with the customer who retained the advertising vendor.

In another preferred embodiment, the methods of the invention further include a step of sharing a proportion of said fee for using the Internet-based platform with a person who referred the customer to the Internet-based platform.

In one embodiment, the methods of the invention further include providing a review system on the Internet-based platform, whereby customers (e.g., brides and brides-to-be) are able to rate and/or provide reviews of advertising vendors.

In one embodiment, a particular advertising vendor's appearance on the Internet-based platform is determined based on the review system.

### BRIEF DESCRIPTION OF THE DRAWINGS

FIG. 1 is a block diagram of an architecture for exemplary hardware that may be used to practice the invention.

FIG. 2 is an exemplary flowchart of the main steps of the claimed methods.

### DETAILED DESCRIPTION OF THE INVENTION

The invention is generally based on providing an Internet-based platform for vendors of wedding-related services (referred to as “advertising vendors” in the instant patent application), whereby the advertising vendors are not charged anything of value (e.g., any sign-up fees or any monthly fees) for advertising on said Internet-based platform unless and until a contract for wedding-related goods and/or services is entered into between the advertising vendors and customers brought together through the Internet-based platform.

As used in the patent application, the term “advertising vendor” refers to all vendors of wedding-related goods and/or services. This term includes, but is not limited to, the following categories of advertising vendors: bakers, providers of banquet rooms, beauty salons, bridal shops, caterers, dancing instructors, DJ's, musicians, florists, formal wear, providers of invitation services, jewelers, limousine companies, photographers, videographers, wedding planners, decorators, equipment rentals, and the like.

As used in this patent application, the term “Internet-based platform” generally refers to an interactive advertising system, standards, and methodology that enable the interactive marketing. The “Internet-based platform” is accessible through an Internet website and is maintained on one or more computers.

The provided methods of arranging contacts for wedding-related goods and/or services are implemented through a computer.

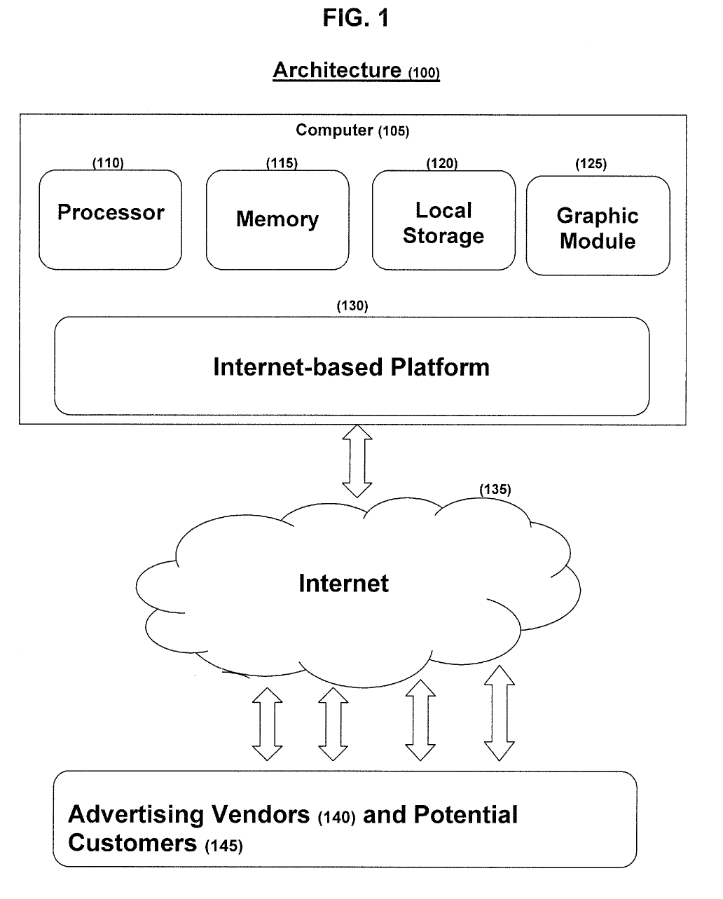

FIG. 1 is a block diagram of an architecture for hardware needed for the invention. The architecture (100) includes a personal computer (105). Personal computer (105) generally includes a processor (110), memory (115), a local storage device (120) and a graphics module (125). The Internet-based platform (130) is provided on said computer (105). Personal computer (105) may actually be one or more computers that contain the architecture needed for said Internet-based platform to operate. The architecture may include any electronic device, including servers, transmission media, etc, that may be needed for proper functioning of said Internet-based platform.

Advertising vendors (140) and potential customers (145) access said Internet-based platform (130) through the Internet (135). There is not any limitation on the specifics of how the access through the Internet is conducted. Generally, any computer or hand-held device that is connected to the Internet can be used to access said Internet-based platform (130).

In one embodiment, the invention provides a method of arranging contracts for wedding-related goods and/or services, the method including the steps of:

setting up an Internet-based platform through which:
a) advertising vendors offer wedding-related goods and/or services; and
b) customers identify the advertising vendors' offered goods and/or services;
facilitating negotiation of contracts for the wedding-related goods and/or services between the advertising vendors and customers brought together through the Internet-based platform; and
charging said advertising vendors a fee for offering wedding-related goods and/or services only in the event that a contract for wedding-related goods and/or services is entered into between said advertising vendors and customers brought together through the Internet-based platform.

The term “facilitating,” as used in the present application, broadly refers to enabling customers and advertising vendors to come into contact with each other and facilitating negotiation of contracts therebetween.

The information that advertising vendors may provide on the Internet-based platform includes, but is not limited to, a business name, a business address, an electronic mail address, a telephone number, and a facsimile number.

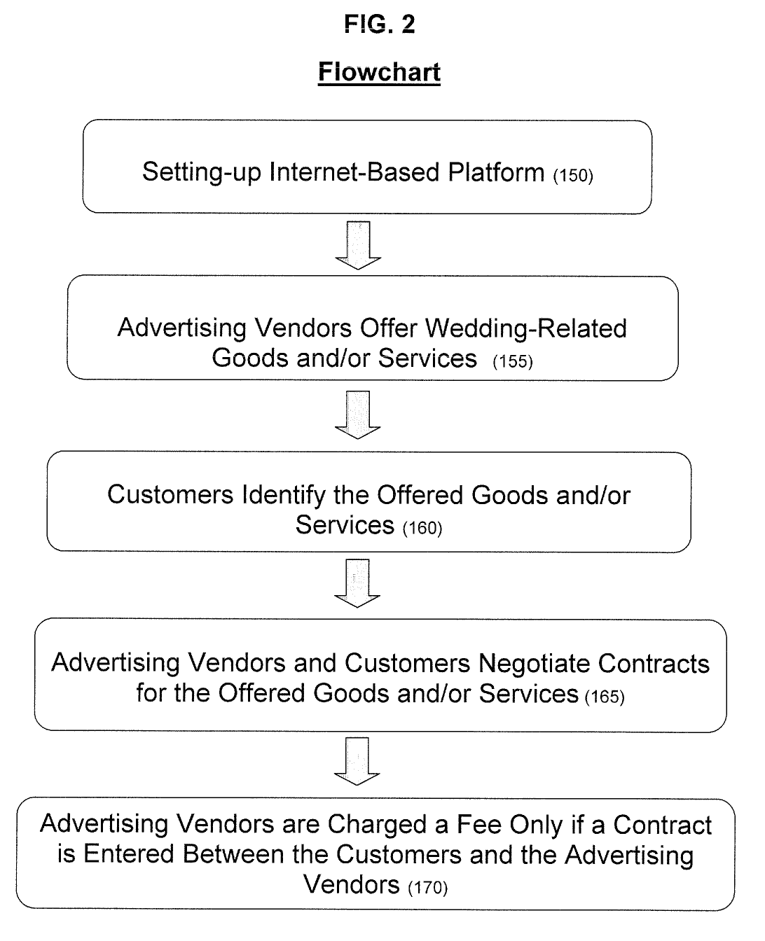

FIG. 2 is a flowchart that represents the main steps of the claimed methods.

First, an Internet-based platform is set up (box 150). Then, advertising vendors offer wedding-related goods and/or services on the Internet-based platform (box 155). Customers identify the offered goods and/or services (box 160). Advertising vendors and customers negotiate contracts for the offered goods and/or services (box 165). Advertising vendors are charged a fee only if a contract is entered between the customers and the advertising vendors for the offered goods and/or services (box 170).

In a preferred embodiment, the methods of the invention further comprise a step of sharing a proportion of said fee for using the Internet-based platform with the customer who retained the advertising vendor. There is not any limitation on the exact proportion of the fee that is to be shared with the customer. This proportion may be varied, as needed, depending, for example, on particular business needs, time of the year, etc. In one embodiment of the invention, the proportion to be shared with the customer is between about 5% and about 10% of the advertising fees.

In another preferred embodiment, the method further involves sharing a proportion of said fee for using the Internet-based platform with a person who referred the customer to the website (who may be referred to as “referral agent”). There is not any limitation on the exact proportion of the advertising fees that are to be shared with the referral agent. This proportion may be varied, as needed, depending, for example, on particular business needs, time of the year, etc. In one embodiment of the invention, the proportion to be shared with the referral agent is about 1% of the total fee charged for using the Internet-based platform.

In one embodiment, the methods of the invention further include providing a review system on the Internet-based platform, whereby customers (e.g., brides) are able to rate and/or provide reviews of advertising vendors.

In one embodiment, a particular advertising vendor's order of appearance on the Internet-based platform is determined based on the review system. For example, reviews for an advertising vendor may be assigned a weighting parameter. In one embodiment, the score of the review may be used as a weighting parameter. In one embodiment, the order of appearance of the advertising vendors on the Internet-based platform relative to other advertising vendors is determined based on the weighting parameter: the higher the weighting parameter, the higher is the position of the advertising vendor relative to other advertising vendors.

However, in one embodiment of the invention, new advertising vendors may appear under a separate category, named, for example, “New Vendors.” After a particular vendor has advertised through the provided Internet-based platform for a certain amount of time (for example, one month), it may be removed from the “New Vendors” category and moved into a regular, review-based category of advertising vendors. There are many variations of organizing the appearance of vendors through provided Internet-based platform.

The detailed description set forth above is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details.

1. A method of arranging contracts for wedding-related goods and/or services, the method comprising the steps of:
setting up an Internet-based platform through which:
a) advertising vendors offer wedding-related goods and/or services; and
b) customers identify the advertising vendors' offered goods and/or services;
facilitating negotiation of contracts for the wedding-related goods and/or services between the advertising vendors and customers brought together through the Internet-based platform; and
charging said advertising vendors a fee for offering wedding-related goods and/or services only in the event that a contract for wedding-related goods and/or services is entered into between said advertising vendors and customers brought together through the Internet-based platform.

2. The method of claim 1, wherein said Internet-based platform allows said advertising vendors to provide information comprising a business name, a business address, an electronic mail address, a telephone number, and a facsimile number.

3. The method of claim 1, further comprising the step of sharing a proportion of said fee for advertising on said Internet-based platform with said customers who entered into a contract for wedding-related goods and/or services with said advertising vendors and wherein said customers and said advertising vendors were brought together through the Internet-based platform.

4. The method of claim 1, further comprising the step of sharing a proportion of said fee for advertising on said Internet-based platform with a person who referred said customer to said Internet-based platform.

5. The method of claim 1, further comprising the step of providing a review system on said Internet-based platform that enables customers to rate and/or provide a review of advertising vendors, wherein said advertising vendors receive a review score.

6. The method of claim 5, further comprising the step of assigning an increased weighting parameter to one or more vendors based on the respective review scores received by each vendor.

7. The method of claim 1, further comprising the step of determining an advertising vendor's order of appearance on said Internet-based platform relative to other advertising vendors based on said weighting parameter.
